(19) United States
(12) Patent Application Publication
(10) Pub. No.: US 2022/0340327 A1
(43) Pub. Date: Oct. 27, 2022

(54) PACKAGING BOX

(71) Applicant: KIMOTO CO., LTD., Saitama (JP)

(72) Inventor: Tomoyuki TAKEGASA, Saitama (JP)

(21) Appl. No.: 17/403,439

(22) Filed: Aug. 16, 2021

(30) Foreign Application Priority Data
Apr. 27, 2021 (JP) 2021-74717

(51) Int. Cl. B65D 5/54; B65D 85/671

(52) U.S. Cl. CPC B65D 5/54; B65D 85/671

(57) ABSTRACT

A packaging box capable of improving unpacking performance in a packing body housing a rolled product is provided. The packaging box comprises a lower case for forming a space for housing a rolled product, which is a long material rolled around an axis in a longitudinal X direction, and an upper cover for sealing the space in the lower case. The upper cover comprises a rectangular top board portion for sealing the space in the lower case and a plurality of sideboard portions extending downward in the vertical Z direction from respective sides of the top board portion, and the plurality of sideboard portions cover approximately all of outer surfaces of the lower box body. At least one of the sideboard portions has a pair of perforations extending upward from a lower end thereof toward the top board portion. By cutting the perforations, a sideboard piece surrounded by the perforations and a lower side of the sideboard portion can be detached.

### BACKGROUND OF THE INVENTION

### Field of the Invention

The present invention relates to a lid-and-body type, that is a two-piece type, packaging box suitable for packaging heavy rolled products, which are rolled long films.

### Description of the Related Art

As a packaging box of this kind, a packing body formed by covering a lower case housing a rolled product therein with an upper cover so as to pack a rolled product has been known (Patent Document 1). In the patent document 1, in order to improve efficiency of unpacking, it is proposed to configure the upper cover with a top board portion covering all of the inside of the lower case and a sideboard portion vertically extending downward from respective sides of the top board portion to cover approximately all side surfaces of the lower case, and to provide a cutout portion to any one of the lower sides of the upper cover.

### RELATED ART DOCUMENTS

### Patent Document

Patent Document 1: Japanese Patent Unexamined Patent Publication (Kokai) No. 2016-84182

### SUMMARY OF THE INVENTION

Even in the technique in the patent document 1, however, improvement of workability at unpacking by an operator has been still insufficient and there have been demands for the improvement.

An object of the present invention is to provide a packaging box capable of improving unpacking performance of the packing body housing a rolled product therein.

Below, to facilitate understanding of the present invention, an explanation will be made with reference numbers corresponding to those in the drawings illustrating an embodiment of the present invention, however, the present invention is not limited to those.

To attain the above object, the packaging box for rolled products (1) according to present invention comprises a lower case (2) for forming a space (23) for housing a rolled product, which is a long material rolled around an axis in the longitudinal (X) direction, and an upper cover (4) for sealing the space (23) in the lower case (2), wherein

the upper cover (4) comprises a rectangular top board portion (42) for sealing the space (23) in the lower case (2) and a plurality of sideboard portions (44a, 44b, 44c and 44d), which extend downward in the vertical (Z) direction from the respective sides of the top board portion (42), for covering approximately all of outer surfaces of the lower case (2);

at least one (44a, 44c, or 44a and 44c) of the sideboard portions (44a, 44b, 44c and 44d) has a pair of perforations (49a and 49a, or 49c and 49c) extending upward from its lower end toward the top board portion (42) formed thereon; and

it is configured that, by cutting the perforations (49a and 49a, or 49c and 49c), a sideboard piece (50) surrounded by both of the perforations (49a and 49a, or 49c and 49c) and a lower side of the sideboard portion (44a or 44c) can be detached.

The pair of perforations (49a and 49a, or 49c and 49c) may be formed at positions axisymmetric with respect to a straight line extending in the vertical (Z) direction at the center in a width (X or Y) direction of a sideboard portion (44a or 44c).

The pair of perforations (49a and 49a, or 49c and 49c) may be formed at predetermined positions closer to the center being away in the width (X or Y) direction from both ends of the sideboard portions (44a, 44c).

In the packaging box (1) above, the perforations (49a and 49a, or 49c and 49c) are configured by a line of collective small holes, a cut length of the small holes in the vertical (Z) direction may be 5 mm or more and 50 mm or less and a distance (remaining length) between two small holes adjacent in the vertical (Z) direction may be 2 mm or more and 20 mm or less.

In the packaging box (1) above, a cutout handle part (52a, 52c) may be formed for a hand to hook at unpacking. In this case, by holding the handle part (52a, 52c) and lifting upward in the vertical (Z) direction while pulling toward oneself, both of the perforations (49a and 49a, or 49c and 49c) can be cut easily.

In the packaging box (1) above, the handle part (52a, 52c) may be a rectangular shape having corners and a lower long side thereof is open to form an upside-down U shape.

The packaging box according to the present invention has, on at least one of the plurality of sideboard portions configuring a body part of the upper cover, a pair of perforations formed thereon extending upward toward the top board portion from a lower side thereof, and it is configured that a sideboard piece surrounded by both of the perforations and a lower side of the sideboard portion can be detached as a result of cutting both of the perforations. Therefore, the packing body formed for packing a rolled product can obtain improved unpacking performance comparing with the case of a packaging box having a conventional configuration. Note that “packing a rolled product” has the same meaning as producing a packing body. “Packing body” indicates the packaging box of the present invention housing (packing) a rolled product as an object to be packed therein, and “unpacking” indicates an operation of unpacking the packing body.

### BRIEF DESCRIPTION OF DRAWINGS

FIG. 1A is a perspective view showing an exemplified use condition of a packaging box according to an embodiment of the present invention.

FIG. 1B is a perspective view showing an example of an upper cover composing the packaging box in FIG. 1A.

FIG. 1C is a perspective view showing an example of a lower case composing the packaging box in FIG. 1A/FIG. 1D is an explanatory view of an example of around a lower end of a narrow-width sideboard portion 44a composing the upper cover in FIG. 1B.

FIG. 1E is an enlarged view of a 1E part surrounded by a dot-dash-line in FIG. 1B.

FIG. 1F is a perspective view showing another example of the upper cover composing the packaging box in FIG. 1A.

FIG. 2A is an exemplified view of a deployed state of the upper cover in FIG. 1B.

FIG. 2B is an exemplified view of preparing pieces in the deployed state in FIG. 2A.

FIG. 2C is an exemplified view of the lower case in FIG. 1C in a deployed state.

FIG. 2D is an exemplified view of preparing pieces in the deployed state in FIG. 2C.

FIG. 3 is an exemplified perspective view showing the lower case in FIG. 1C in a used state.

FIG. 4 is an exemplified perspective view of an unpacked state of the packing body holding a rolled product in the packaging box in FIG. 1A.

### DETAILED DESCRIPTION OF THE INVENTION

Below, embodiment(s) of the packaging box according to the present invention will be explained with reference to the drawings.

First, an overview of the entire configuration will be explained.

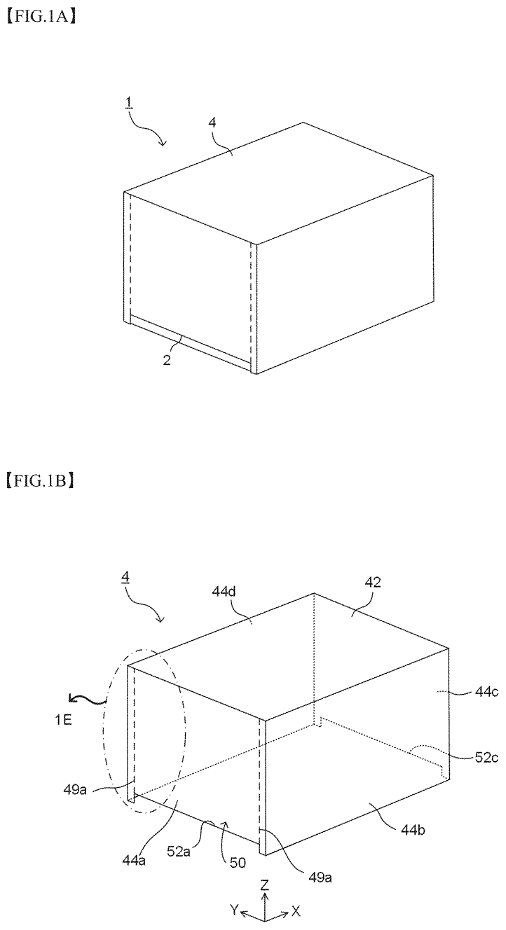

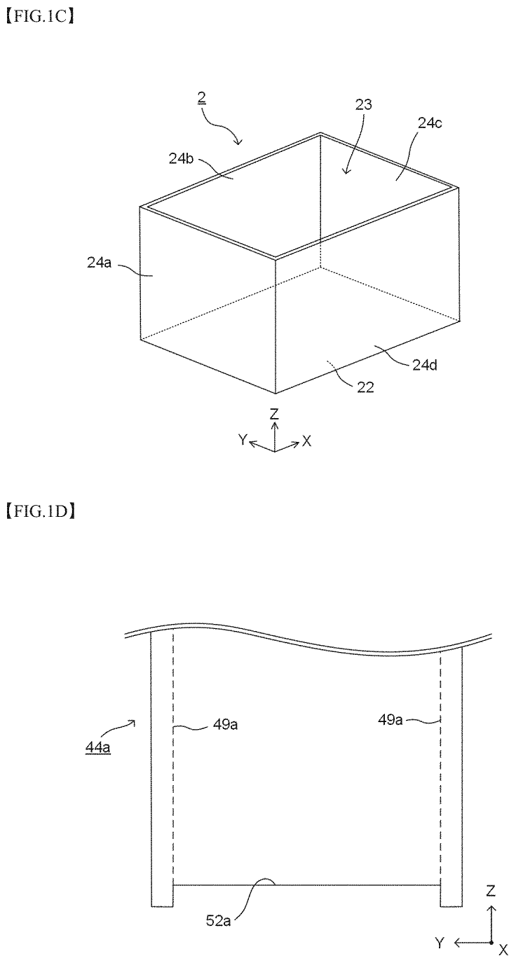

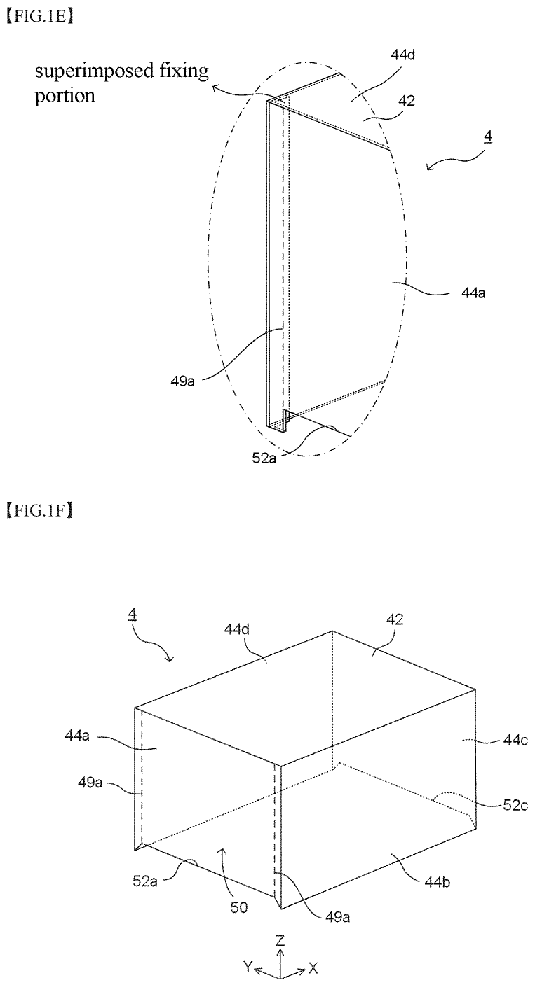

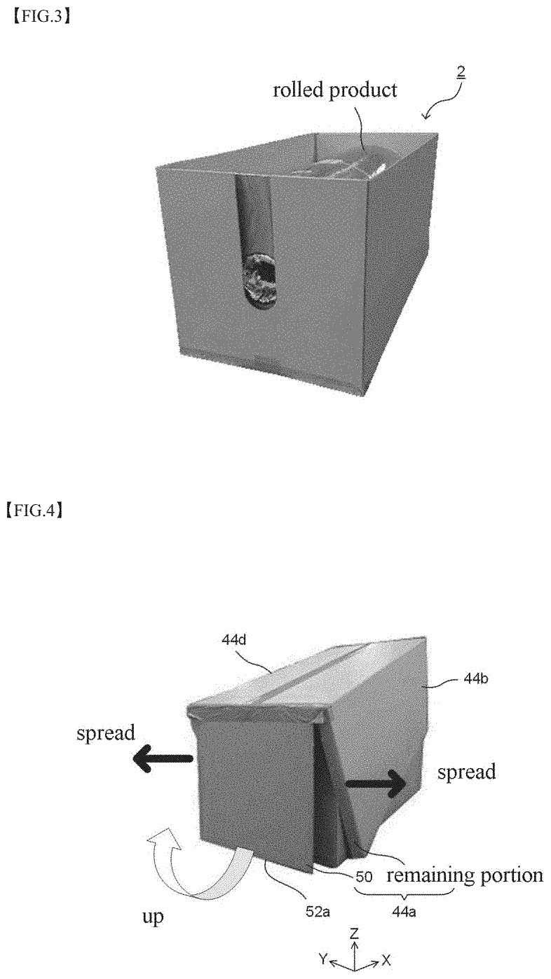

As shown in FIG. 1A, FIG. 1B and FIG. 1C, the packaging box 1 for rolled product according to an embodiment of the present invention (hereinafter, simply referred to as “the packaging box 1”) is used for housing (refer, for example, to FIG. 3) and packing a rolled product, which is a long material rolled around an axis in the longitudinal X direction (hereinafter, simply referred to as “the X direction”), and comprises a lower case 2 forming a space 23 for housing the rolled product and an upper cover 4 for sealing the space 23 in the lower case 2. It is configured to be a lid-and-body type, that is a two-piece type.

As shown in FIG. 1C, the lower case 2 has, at its lower part, a rectangular bottom board portion 22 having a pair of long sides extending along the X direction and a pair of short sides extending along the width Y direction perpendicular to the X direction (hereinafter, simply referred to as “the Y direction”).

At the respective sides (long sides and short sides) of the bottom board portion 22, a pair of narrow-width sideboard portions 24a and 24c facing to each other in approximately parallel and a pair of wide-width sideboard portions 24b and 24d facing to each other in approximately parallel position upright in the vertical Z direction (hereinafter, simply referred to as “the Z direction”) perpendicular to both of the X and Y directions, so that the four sideboard portions 24a, 24b, 24c and 24d configure the rectangular parallelepiped lower box body part. A space surrounded by the four sideboard portions 24a, 24b, 24c and 24d is a space 23 for housing a rolled product (refer to FIG. 3) on the bottom board portion 22. To close the space 23 surrounded by the sideboard portions 24a, 24b, 24c and 24d, the upper cover 4 is placed downward in the Z direction to cover from the upper end sides of the sideboard portions 24a, 24b, 24c and 24d. A rate of each of the long sides and each of the short sides on the bottom board portion 22 side of the space 23 is determined in consideration of an axis length (X direction) of the rolled product to be housed and a diameter (Y direction) of a rolled long product. The ratio of the long side and short side is about 2:1 in one mode.

As shown in FIG. 1B, the upper cover 4 has, at its upper portion, a rectangular top board portion 42 for sealing the space 23 in the lower case 2. The top board portion 42 has a pair of long sides extending along the X direction and a pair of short sides extending along the Y direction. At the respective sides of the top board portion 42, a pair of narrow-width sideboard portions 44a and 44c facing to each other in approximately parallel and a pair of wide-width sideboard portions 44b and 44d facing to each other in approximately parallel, which connect both end portions of the narrow-width sideboard portions 44a and 44c, extend downward in the Z direction. These four sideboard portions 44a, 44b, 44c and 44d form the rectangular parallelepiped upper cover portion. The upper cover portion is designed to be a size (refer to FIG. 1A) capable of covering approximately all of the lower case portion (sideboard portions 24a, 24b, 24c and 24d) of the lower case 2 shown in FIG. 1C from outside.

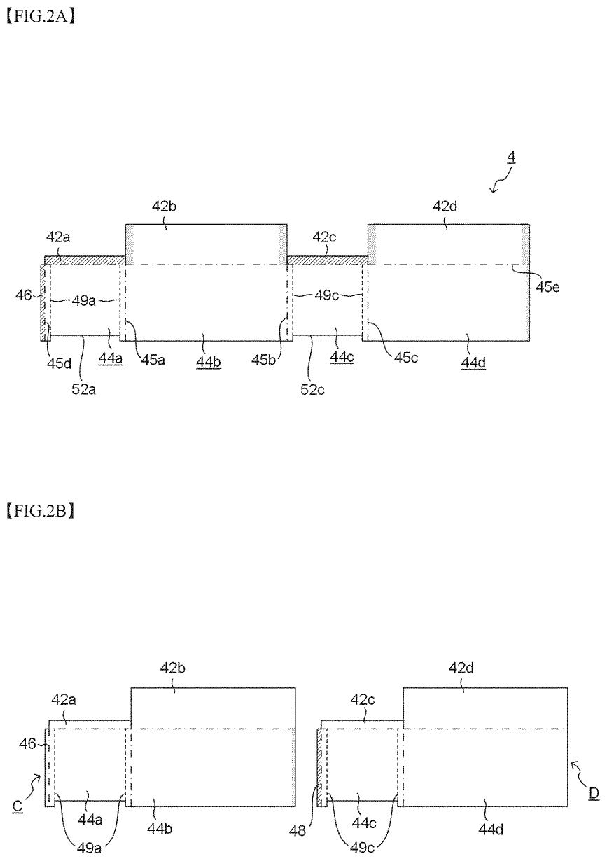

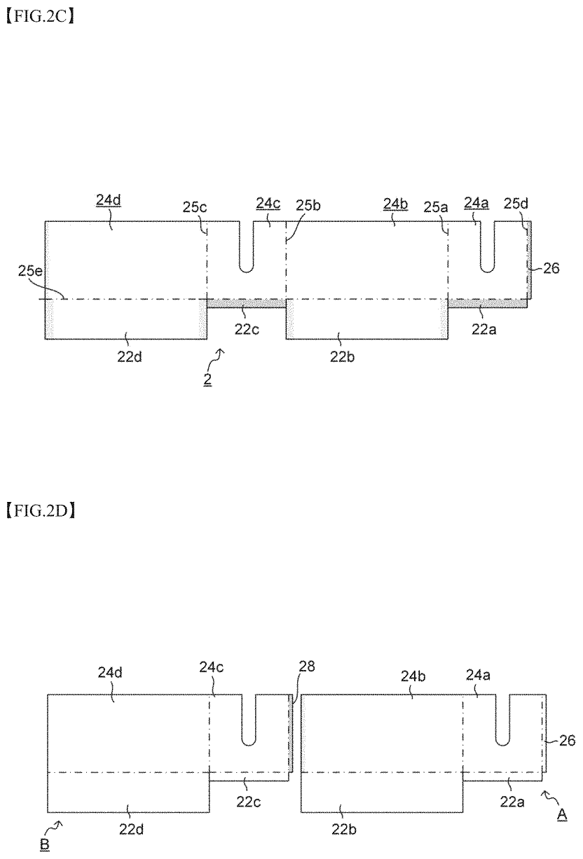

The lower case 2 and the upper cover 4 are formed by paper or plastic cardboard (hereinafter, referred to as “a cardboard plate”), for example, as shown in FIG. 2A and FIG. 2C. Both or either one of the lower case 2 and the upper cover 4 may be formed by other material (for example, a thick paper, kraft paper, paper board and plastic plate, etc.) besides cardboard plates. A thickness of the cardboard plate, etc. to be used is not particularly limited and may be determined arbitrarily in a range that required strength can be secured. It may be, for example, about 5 mm or thicker and 20 mm or thinner (about 8 mm as an example).

Next, an example of deployed structure will be explained.

As shown in FIG. 2C, four sideboard portions 24a, 24b, 24c and 24d forming a body part of the lower case 2 are connected and able to be folded at fold lines 25a, 25b and 25c. A margin for sticking 26 is provided to the narrow-width sideboard portion 24a via the fold line 25d at its end portion on the opposite side of the wide-width sideboard portion 24b.

The bottom board portion 22 (refer to FIG. 1C) may be configured by four bottom lid flaps 22a, 22b, 22c and 22d connected to below the sideboard portions 24a, 24b, 24c and 24d via the fold line 25e.

The lower case 2 of the present example having the deployed structure as above may be assembled as explained below.

First, the narrow-width sideboard portion 24a is folded at the fold line 25a, the wide-width sideboard portion 24b is folded at the fold line 25b and the narrow-width sideboard portion 24c is folded at the fold line 25c at an angle of 90 degrees, respectively. Then, the margin for sticking 26 provided to the narrow-width sideboard portion 24a is folded at the fold line 25d at an angle of 90 degrees, brought to superimpose with the wide-width sideboard portion 24d so that the margin 26 comes inward and fixed. The fixing means is not particularly limited and may be fixed with an adhesive agent, etc.

Next, a pair of inner flaps (bottom lid flaps 22a and 22c) are folded at the fold line 25e at an angle of 90 degrees, then a pair of outer flaps (bottom lid flaps 22b and 22d) are folded at the fold line 25e at an angle of 90 degrees so as to cover over the inner flaps. In a state where ends of both of the outer flaps meet, they are connected with a not shown means for connecting the flaps (an adhesive tape, etc.). As explained above, the lower case 2 is assembled.

Note that, as the lower case 2 in the present example, other than the integrally-formed cardboard configured as shown in FIG. 2C, what formed from a plurality of pieces as shown, for example, in FIG. 2D may be used, as well. Specifically, for example, a method of preparing a piece A and a piece B and putting them together via a margin for sticking 28 to obtain a cardboard plate (obtained by preparing a piece A composed of the narrow-width sideboard portion 24a, wide-width sideboard portion 24b, bottom lid inner flap 22a, bottom lid outer flap 22b and margin for sticking 26 and a piece B composed of the narrow-width sideboard portion 24c, wide-width sideboard portion 24d, bottom lid inner flap 22c, bottom lid outer flap 22d and margin for sticking 28, superimposing the margin for sticking 28 of the piece B on the wide-width sideboard portion 24b of the piece A, so that the margin for sticking 28 comes on an inner surface of the space 23 when assembled, and fixing with an adhesive agent, etc.), etc. may be mentioned.

As shown in FIG. 2A, the four sideboard portions 44a, 44b, 44c and 44d composing the body part of the upper cover 4 are connected and able to be folded at fold lines 45a, 45b and 45c. A margin for sticking 46 is provided to the narrow-width sideboard portion 44a via the fold line 45d at its end portion on the opposite side of the wide-width sideboard portion 44b. Note that, instead of providing the margin for sticking 46 to the narrow-width sideboard portion 44a at an end portion on the opposite side of the wide-width sideboard portion 44b (refer to FIG. 2A), the margin for sticking 46 may be provided to the wide-width sideboard portion 44d at an end portion on the opposite side of the narrow-width sideboard portion 44c. Namely, it would be sufficient if the margin for sticking 46 is provided to the narrow-width sideboard portion 44a (or wide-width sideboard portion 44d) at an end portion on the opposite side of the wide-width sideboard portion 44b (or narrow-width sideboard portion 44c), which positions on the right or on the left when deployed.

The top board portion 42 (refer to FIG. 1B) may be configured by four upper lid flaps 42a, 42b, 42c and 42d connected to the upper side of the sideboard portions 44a, 44b, 44c and 44d via the fold line 45e as shown, for example, in FIG. 2A.

The upper cover 4 in the present example having the deployed structure as above is assembled as explained below.

First, the narrow-width sideboard portion 44a is folded at the fold line 45a, the wide-width sideboard portion 44b is folded at the fold line 45b, and the narrow-width sideboard portion 44c is folded at the fold line 45c, then, the margin for sticking 46 provided to the narrow-width sideboard portion 44a is folded at the fold line 45d at an angle of 90 degrees, superimposed on the wide-width sideboard portion 44d, so that the margin 46 comes inside and fixed. In this case, when assembled, inside the narrow-width sideboard portion 44a formed with the handle part 52a does not have any superimposed fixing portion of the margin for sticking 46 (refer to FIG. 1E). On the other hand, when using the one wherein the margin for sticking 46 is provided to the wide-width sideboard portion 44d at an end portion on the opposite side of the narrow-width sideboard portion 44c, when assembled, a superimposed and fixed portion of the margin for sticking 46 exists on an inner surface of the narrow-width sideboard portion 44a, on which the handle part 52a is formed. The fixing means is not particularly limited and an adhesive agent, etc. may be mentioned.

Next, a pair of inner flaps (the upper lid flaps 42a and 42c) are folded at the fold line 45e and, then, a pair of outer flaps (upper lid flaps 42b and 42d) are folded at the fold line 45e. In a state where ends of the outer flaps meet, they are connected by a not shown means for connecting the flaps (an adhesive tape, etc.). In this way, the upper cover 4 is assembled.

Note that, as the upper cover 4 in the present example, other than the integrally-formed cardboard plate as shown in FIG. 2A, what formed by a plurality of pieces, for example, as shown in FIG. 2B may be used, as well. Specifically, a cardboard plate obtained, for example, by preparing a piece C and a piece D and connecting the two via a margin for sticking 48 (a piece C composed of the narrow-width sideboard portion 44a, wide-width sideboard portion 44b, upper lid inner flap 42a, upper lid outer flap 42b and margin for sticking 46 and a piece D composed of the narrow-width sideboard portion 44c, wide-width sideboard portion 44d, upper lid inner flap 42c, upper lid outer flap 42d and margin for sticking 48 are superimposed, so that the margin for sticking 48 of the piece D comes inside of the wide-width sideboard portion 44b of the piece C when assembled and fixed by an adhesive, etc.), etc. may be mentioned.

Next, an explanation will be made on characteristic parts of the present example.

<Perforations>

In one mode as shown in FIG. 1B and FIG. 2A, among the four sideboard portions configuring the upper cover part of the upper cover 4, the narrow-width sideboard portion 44a and narrow-width sideboard portion 44c extending downward in the Z direction from both short sides of the top board portion 42 are provided with a pair of perforations 49a and 49a and a pair of perforations 49c and 49c respectively formed thereon extending upward in the Z direction from lower ends, which are on the opposite side from the upper ends on the top board portion 42 side. The running direction of the perforations 49a, 49a, 49c and 49c is not strictly along the Z direction and would be enough if they run from the lower ends of the narrow-width sideboard portions 44a and 44c toward the direction of the top board portion 42. Here, “toward the direction of the top board portion 42” includes running in the direction of some angle from the Z direction.

The perforations 49a, 49a, 49c and 49c in the present example are configured by collective small holes lined up along the Z direction. When a pair of perforations 49a and 49a (or 49c and 49c) are cut, a sideboard piece 50 (refer to FIG. 4) surrounded by a side (lower side) of the narrow-width sideboard portion 44a (or 44c) on the opposite side of the top board portion 42 and the pair of perforations 49a and 49a (or 49c and 49c) can be detached from the rest (refer to FIG. 4) of the narrow-width sideboard portion 44a (or 44c).

“Positions” of arranging the pair of perforations 49a and 49a (or 49c and 49c) are not particularly limited but, for example, as shown in FIG. 1B and FIG. 2A, positions axisymmetric with respect to a straight line extending in the Z direction at the center in the Y direction of the narrow-width sideboard portion 44a (or 44c) are preferable. More preferably, the perforations are formed at predetermined positions, which are close to the center (inner side) from the both ends in the Y direction keeping a predetermined distance from the ends (for example, 0.5 mm or more and 1500 mm or less, preferably 10 mm or more and 1000 mm or less, and more preferably 30 mm or more and 70 mm or less). When the “positions” of a pair of perforations 49a and 49a (or 49c and 49c) are provided closer to the center from the both ends in the Y direction (mentioned above), it becomes easier to cut the perforations 49a and 49a (or 49c and 49c), however, when they are formed too close to the center (mentioned above), it is liable that adjacent narrow-width sideboard portions 44b and 44d become hard to open when cutting the perforations 49a and 49a (or 49c and 49c). Note that in the case where the superimposed and fixed portion of the margin for sticking 26 exists on an inner surface of the narrow-width sideboard portion 44a, on which a handle part 52a is formed (not shown), when the perforation 49a is close to an end portion of the superimposed fixed portion on the perforation 49a side (short distance), the perforations become easier to be cut. Therefore, in terms of easiness of cutting perforations, it is preferable that a perforation formed near a superimposed and fixed portion is provided at a close position from an end portion of the superimposed and fixed portion.

“A length of the line of small holes (in the Z direction)” forming the perforations 49a, 49a, 49c and 49c is not particularly limited but in terms of easiness of cutting and strength, it is desired to be, for example, 5 mm or more and 50 mm or less or so and preferably 10 mm or more and 40 mm or less. When the length of the line is long, it becomes easier to cut the perforations 49a, 49a, 49c and 49c, however, when it is too long, strength in the Z direction tends to decline. “A distance between adjacent two holes (remaining length in the Z direction)” is not particularly limited, either, however, in terms of easiness of cutting, it is desired to be, for example, 2 mm or more and 20 mm or less or so and preferably 5 mm or more and 15 mm or less. When the remaining length is too long, it is liable that perforations 49a, 49a, 49c and 49c become hard to be cut.

“A width of the small holes (in the Y direction)” forming the perforations 49a, 49a, 49c and 49c is not particularly limited, either, however, when it is too large, strength in the Z direction tends to decline. Therefore, “a width of the small holes (Y direction)” may be designed arbitrarily in a range of maintaining the strength.

It is preferable that the perforations 49a, 49a, 49c and 49c are formed from the lower end to the upper end of the narrow-width sideboard portions 44a and 44c as shown in FIG. 1B and FIG. 2A, however, it is not always necessary to form to the upper end and may be formed halfway. A length of the perforations 49a, 49a, 49c and 49c from the lower end of the narrow-width sideboard portions 44a and 44c toward the top board portion 42 (hereinafter, simply referred to as “a length of perforations”) may be two thirds of the full length from the lower end to the upper end of the narrow-width sideboard portions 44a and 44c (hereinafter, simply referred to as “the height of the sideboard portion”). When the length of perforations is two thirds of the height of the sideboard portion, the effect of the invention can be expected.

Note that, as will be explained later on, when the handle part 52a and 52c are provided on the pair of narrow-width sideboard portions 44a and 44c and the handle parts 52a and 52c have an upside-down U shape as shown in FIG. 1D, it is preferable that the perforations 49a and 49c are provided upward in the Z direction from the upper ends of both short sides on the right and left of the rectangle as shown in FIG. 1B and FIG. 2A. On the other hand, when the handle parts 52a and 52c provided to the pair of narrow-width sideboard portions 44a and 44c are the shape as shown in FIG. 1F, the perforations 49a and 49c are preferably provided upward in the Z direction from both ends of the top side of the trapezoid as shown in FIG. 1B and FIG. 2A.

<Handle Part>

Although it is not essential in the present invention, in one mode, cutout handle parts 52a and 52c may be provided for hands of an operator to hook when unpacking. Thereby, it becomes easy to hook finger(s) at the lower ends of the upper cover 4 when unpacking the packaging box 1 and it is possible to furthermore contribute to an improvement of workability at unpacking the packaging box 1.

A position, size and shape of the handle parts 52a and 52c to be provided are not particularly limited, but preferably they are at positions of equal distance from both end portions in the Y direction. The handle parts 52a and 52c may have a size (a width in the Y direction) allowing one or two fingers of an operator to hook. Their shape may be decided freely. In terms of easiness of forming, for example, an upside-down U shape (refer to FIG. 1D) is basic, which is a rectangular shape having corners and with the lower long side open, and it is preferable that the shape is suitably modified but it is not limited to this shape. It may be a trapezoidal shape having corners and with the bottom side (the long side) excluded (refer to FIG. 1F) or may be an arc shape with no corners (not shown).

The handle part may be provided only on one end portion of the narrow width sideboard portions 44a and 44c. Onsite operation may be often done by only one person, so that considering such situation, a handle part 52a (or 52c) only on one narrow-width sideboard portion 44a (or 44c) would be able to improve workability sufficiently and it may also result in reducing production cost of the upper cover 4.

Next, the effects will be explained.

When unpacking a packing body, which is a packaging box 1 housing a rolled product, (that is, an operation of opening the packing body), the operator stands in front of either one (for example, the narrow-width sideboard portion 44a) of the narrow-width sideboard portions 44a and 44c of the upper cover 4 as shown in FIG. 1B and FIG. 4 first, then, while bending down a bit, he/she hooks his/her finger(s) at the handle part 52a of the narrow-width sideboard portion 44a and lifts upward in the Z direction while pulling toward oneself in the X direction so as to cut the perforations 49a and 49a and pushes up the sideboard piece 50 surrounded by the handle part 52a and a pair of perforations 49a and 49a. When the sideboard piece 50 is cut out from the narrow-width sideboard portion 44a, an air goes naturally into inside the upper cover 4, and the wide-width sideboard portions 44b and 44d opens as a result of pushing up the sideboard piece 50 (refer to FIG. 4), so that efficiency of unpacking improves.

Also, while pushing up the sideboard piece 50, the operator holds the other handle part 52c and lifts the other narrow-width sideboard portion 44c upward in the Z direction. During this, he/she may either cut or not cut the perforations 49c and 49c. From the above, opening of the packing body completes.

According to the packaging box 1 in the present example, among a plurality of sideboard portions configuring the rectangular parallelepiped body portion of the upper cover 4, the narrow-width sideboard portions 44a and 44c extending downward in the Z direction from both short sides of the top board portion 42 are provided respectively with a pair of perforations 49a and 49a and a pair of perforations 49c and 49c. Since it is configured that, by cutting either pair of the perforations 49a and 49a and perforations 49c and 49c, a sideboard piece 50 surrounded by a pair of perforations 49a and 49a and a lower side of the narrow-width sideboard portion 44a or a sideboard piece 50 surrounded by a pair of perforations 49c and 49c and a lower side of the narrow-width sideboard portion 44c can be detached, the unpacking performance can be improved in the packing body formed by packing a rolled product comparing with the case of packing in a packaging box having a conventional configuration not provided with those specific perforations 49a, 49a, 49c and 49c (for example, the technique according to the patent document 1).

The embodiment explained above is described for facilitating understanding of the present invention and is not for limiting the present invention. Accordingly, respective elements disclosed in the embodiment above may include all design modifications and equivalents belonging to the technical range of the present invention.

### DESCRIPTION OF NUMERICAL NOTATIONS

1 . . . packaging box
2 . . . lower case
   22 . . . bottom board portion
   22a, 22c . . . bottom lid inner flaps (inner flaps)
   22b, 22d . . . bottom lid outer flap (outer flap)
   23 . . . housing space
   24a, 24c . . . narrow-width sideboard portion (sideboard portion)
   24b, 24d . . . wide-width sideboard portion (sideboard portion)
   25a, 25b, 25c, 25d and 25e . . . fold line
   26, 28 . . . margin for sticking
4 . . . upper cover
   42 . . . top board portion
      42a, 42c . . . upper lid inner flap (inner flap)
      42b, 42d . . . upper lid outer flap (outer flap)
   44a, 44c . . . narrow-width sideboard portion (sideboard portion)
   44b, 44d . . . wide-width sideboard portion (sideboard portion)
   45a, 45b, 45c, 45d, 45e . . . fold line
   46, 48 . . . margin for sticking
   49a and 49c . . . perforation
   50 . . . sideboard piece
   52a, 52c . . . handle part

1. A packaging box for a rolled product, comprising a lower case for forming a space for housing a rolled product, which is a long material rolled around an axis in the longitudinal (X) direction, and an upper cover for sealing the space in the lower case, wherein
the upper cover comprises a rectangular top board portion for sealing the space in the lower box body and a plurality of sideboard portions extending downward in the vertical (Z) direction from respective sides of the top board portion, and the plurality of sideboard portions are for covering approximately all of outer surfaces of the lower box body; and
at least one of the sideboard portions is provided with a pair of perforations extending upward from a lower end thereof toward the top board portion, so that a sideboard piece surrounded by both of the perforations and a lower side of the sideboard portion can be detached by cutting the perforations.

2. The packaging box according to claim 1, wherein the pair of perforations are formed at predetermined positions, which are positions axisymmetric with respect to a straight line extending in the vertical (Z) direction at the center in a width (X or Y) direction of a sideboard portion, and closer to the center being away from both ends in the width (X or Y) direction.

3. The packaging box according to claim 2, wherein the perforations are configured by a line of collective small holes, a cut length of the small holes in the vertical (Z) direction is 5 mm or more and 50 mm or less and a distance (remaining length) between two small holes adjacent in the vertical (Z) direction is 2 mm or more and 20 mm or less.

4. The packaging box according to claim 3, wherein a cutout handle part for a hand to hook at unpacking is formed on a lower side of a sideboard portion having perforations formed thereon, and the perforations are cut easily by holding the handle part and lifting upward in the vertical (Z) direction while pulling toward oneself.

5. The packaging box according to claim 4, wherein the handle part is a rectangular shape having corners and a lower long side thereof is open to form an upside-down U shape.

6. The packaging box according to claim 1, wherein the perforations are configured by a line of collective small holes, a cut length of the small holes in the vertical (Z) direction is 5 mm or more and 50 mm or less and a distance (remaining length) between two small holes adjacent in the vertical (Z) direction is 2 mm or more and 20 mm or less.

7. The packaging box according to claim 1, wherein a cutout handle part for a hand to hook at unpacking is formed on a lower side of a sideboard portion having perforations formed thereon, and the perforations are cut easily by holding the handle part and lifting upward in the vertical (Z) direction while pulling toward oneself.

8. The packaging box according to claim 2, wherein a cutout handle part for a hand to hook at unpacking is formed on a lower side of a sideboard portion having perforations formed thereon, and the perforations are cut easily by holding the handle part and lifting upward in the vertical (Z) direction while pulling toward oneself.

9. The packaging box according to claim 7, wherein the handle part is a rectangular shape having corners and a lower long side thereof is open to form an upside-down U shape.

10. The packaging box according to claim 8, wherein the handle part is a rectangular shape having corners and a lower long side thereof is open to form an upside-down U shape.
